(19) United States
(12) Patent Application Publication
(10) Pub. No.: US 2015/0005900 A1
(43) Pub. Date: Jan. 1, 2015

(54) DEVICES AND METHODS OF FUNCTION-BASED CONTROL IN AUTOMATION SYSTEMS

(71) Applicant: Green Edge Technologies, Inc., Poway, CA (US)

(72) Inventors: Scott A. STEELE, Poway, CA (US); William P. ALBERTH, JR., Prairie Grove, IL (US); David K. HARTSFIELD, Poway, CA (US); William D. RICE, San Diego, CA (US)

(21) Appl. No.: 13/927,584

(22) Filed: Jun. 26, 2013

(51) Int. Cl. G05B 15/02

(52) U.S. Cl. CPC G05B 15/02
USPC 700/19; 700/22; 700/275

(57) ABSTRACT

The present disclosure is generally directed to automation systems and methods of use thereof to control devices. More particularly, the present disclosure includes systems including function-based controls and methods of assigning function-based controls to allow a user to add, relocate, and/or remove a device without requiring the user to reprogram the system.

### FIELD OF THE INVENTION

Embodiments of the present disclosure are generally directed to systems, devices, and methods for automating the determination of which devices (e.g., appliances or power delivery components) may be controlled, e.g., by a switch or other suitable actuator, in an automation system. More particularly, the present disclosure includes methods of detecting a function of a switch and determining a set of appliances or power delivery components to be controlled, e.g., by activating a control.

### BACKGROUND OF THE INVENTION

Existing home automation control solutions, such as products supporting the X10 protocol, require a determination of which devices to be controlled be made a priori. If an appliance is added, removed, or moved, then the user must reprogram the home automation system to account for the change. The user also must maintain and manually update a list of which devices are associated with a control to account for any subsequent changes. Further, if reprogramming is not done correctly, modifying the control of one device may disrupt the entire automation system. Thus, modifying automation systems can be time-intensive, complex, and burdensome to the user.

What is needed is a method to at least determine a desired function within an automation system and to dynamically control the relevant appliances or other power delivery components to fulfill the function without requiring wholesale reprogramming of the system.

### SUMMARY OF THE INVENTION

The present disclosure is generally directed toward improving functionality of an automation system by associating or mapping identified appliances and power delivery devices to switches or other actuators that have defined functions. The switches/actuators may be operable over a domain of devices. As appliances are added, moved, or removed from a structure, the associations among appliances and switches may be automatically updated to accommodate such modifications without requiring user input.

In at least one embodiment, the present disclosure includes an automation system, comprising: at least one actuator; at least one device selectively controlled by the actuator; and at least one appliance operably coupled to the at least one device; wherein the actuator is assigned at least one function, the actuator being configured such that when the actuator is actuated, the automation system determines if the appliance is related to the assigned function, and adjusts a supply of power to the device if the appliance is related to the assigned function. Embodiments of the present disclosure may include one or more of the following features: the at least one device may be configured to terminate power to the at least one appliance; a first device may be included in a first domain of devices and a second device may be included in a second domain of devices, wherein: the actuator is assigned to the first domain such that the actuator selectively adjusts a power supply to the first device and to any other device within the first domain of devices; at least one of the first domain or the second domain may include a plurality of devices, wherein each device of the plurality of devices is located in a room, in a group of at least two rooms, in a level of a multi-level structure, completely outside a structure, completely inside a structure, or within a predetermined distance of a wall of a structure; the wall of the structure may include the floor; the at least one device may be an outlet; the at least one assigned function of the actuator may include controlling at least one light, adjusting a temperature, controlling the at least one device, opening a covering, or closing a covering; the at least one assigned function of the actuator may include controlling a plurality of lights such that activating the actuator causes all lights within the first domain to turn on; the at least one assigned function of the actuator may include controlling at least part of two devices located in different rooms of a structure; the at least one assigned function of the actuator may include controlling at least two devices, wherein a first device is located inside a structure and a second device is located outside a structure; the covering may include a garage door, a roof, a window, or a covering to a pool; the at least one actuator may be in wireless communication with the at least one device; the automation system may further comprise at least one mobile device in wireless communication with the actuator, wherein the at least one mobile device is configured to actuate the actuator remotely; the automation system may comprise: a plurality of actuators, each actuator being assigned at least one function; a plurality of devices, each device being selectively controlled by at least one actuator; and a plurality of appliances, each appliance being operably coupled to a device; wherein the automation system further comprises a profile of assignments among each of the actuators, devices, and appliances; the assigned function of each actuator may differ from the assigned functions of the remainder of the plurality of actuators; a first appliance may be assigned to a first actuator and a second actuator, and a second appliance may be assigned to the second actuator; changing a power state of the first appliance may cause a change in power state of the second appliance; changing the power state of the first appliance may include manually adjusting the first appliance; or when the actuator is actuated, the at least one device may provide power to the at least one appliance for a first period of time, and then selectively may not provide power for a second period of time.

In at least one embodiment, the present disclosure further includes a method of controlling devices in an automation system, the method comprising: assigning at least one actuator of a plurality of actuators a function and a domain; connecting a first appliance to a first outlet in communication with at least one actuator of the plurality of actuators; determining if the first appliance is related to the assigned function and domain of each actuator in communication with the first outlet; and if the first appliance is related to the assigned function of at least one actuator in communication with the first outlet, controlling a supply of power to the first outlet with the related at least one actuator. Embodiments of the present disclosure may include one or more of the following features: determining if the first appliance is related to the assigned function and domain of each actuator may include determining an identity of the first appliance by analyzing a power consumption characteristic of the first appliance; the method may further comprise: connecting a second appliance to a second outlet in communication with at least one actuator of the plurality of actuators; determining if the second appliance is related to the assigned function and domain of each actuator in communication with the second outlet, and, if the second appliance is related to the assigned function at least one actuator; controlling a supply of power to the second outlet with the at least one actuator; controlling the supply of power to the first outlet may include providing power, terminating power, increasing an amount of power, or decreasing an amount of power without terminating delivery of power; the at least one actuator may terminate power to the first outlet, wherein the method may further comprise: detecting a change in a power state of the first appliance; and restoring power to the first outlet; the power state of the first appliance may be changed by actuating a power actuator of the first appliance; detecting the change in power state of the first appliance may include measuring electrical impedance; the method may further comprise restoring power to a second outlet; a second appliance may be operably coupled to the second outlet; the first appliance and the second appliance may be included in the same domain; the method may further comprising restoring power to a plurality of devices of the automation system; or the first outlet may be assigned to a first actuator, and disconnecting the first appliance from the first outlet may dissociate the first outlet from the first actuator.

In at least one embodiment, the present disclosure further includes a method of controlling devices in an automation system, wherein the automation system comprises: a plurality of actuators, each actuator being selectively assigned at least one function and at least one domain; a plurality of outlets, each outlet being selectively assigned to at least one actuator; and a plurality of appliances, each appliance being connected to an outlet; the method comprising: disconnecting a first appliance from a first outlet; identifying an assignment of the first outlet to a first actuator; and disassociating the first outlet from the first actuator. Embodiments of the present disclosure may include one or more of the following features: the method may further comprise: identifying an assignment of the first outlet to a second actuator; and disassociating the first outlet from the second actuator; or the method may further comprise connecting the first appliance to a second outlet different from the first outlet; determining if the first appliance is related to the assigned function and domain of each actuator; and if the first appliance is related to the assigned function at least one actuator, controlling a supply of power to the second outlet with the at least one actuator.

In at least one embodiment, the present disclosure further includes an automation system comprising switches assigned to one or more functions. If an appliance is plugged in or otherwise connected to an outlet, and the appliance is related to the function assigned to a particular switch, then the outlet to which the appliance is connected may be assigned or mapped to the switch for control. In some embodiments, if the outlet was previously assigned to a second switch, the previous assignment may be cancelled.

In some embodiments, a switch in an automation system may be assigned to a domain of devices, wherein only devices within the domain may be subject to control by the switch. Exemplary domains include, but are not limited to, a specific room, a level of a house, inside a house, and outside a house. Domains may be selectively defined by a user, automatically determined by an automation system, and/or determined at least partially from information obtained over the Internet.

In another exemplary embodiment, unplugging or otherwise disconnecting an appliance from an outlet associated with a first switch causes the association between the outlet and the first switch to be removed. In some embodiments, the outlet formerly associated with the first switch may then be associated with a second switch. Further, should the unplugged appliance be reconnected, the association between the outlet and the first switch may be re-established.

Various embodiments of automation systems disclosed may include one or more of the following features: at least one outlet including an adaptor configured to be operably coupled with a preexisting electrical outlet; at least one sensor, e.g., a plurality of sensors; the at least one sensor may include a motion sensor, a light sensor, or a temperature sensor; the outlet may include a microprocessor; one of a control unit and the microprocessor may be configured to receive power consumption data for one or more electrical devices from a power monitor; one of the control unit and the microprocessor may be configured to compare the received power consumption data to power consumption data of known electrical devices; one of the control unit and the microprocessor may be configured to identify the one or more electrical devices based on the comparison of the received power consumption data to power consumption data of known electrical devices; the at least one outlet may be configured to detect an electrical noise in a power line generated by the one or more electrical devices; the at least one outlet may be configured to communicate the detected electrical noise to the control unit; the control unit may be configured to compare the detected electrical noise to electrical noise data of known electrical devices; the control unit may be configured to identify the one or more electrical devices based on the comparison of the detected electrical noise to electrical noise data of known electrical devices; the sensor may be configured to detect a radiofrequency signal; a switch operably coupled to the controller and the outlet; the control unit may be configured to communicate with the Internet; a communication link may be configured to allow wireless communication between the outlet and the control unit; and the control unit may be configured to terminate delivery of electrical energy to the at least one outlet based on an input from the at least one sensor, where the assignment of the outlet to the switch is dependent on the identity of the appliance and the relationship between the identity of the appliance and the assigned function of the switch.

It may be understood that both the foregoing general description and the following detailed description are exemplary and explanatory only, and are not restrictive of the disclosure, as claimed. The present invention will be more clearly understood from the detailed description below in conjunction with the accompanying drawings.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 schematically illustrates an exemplary automation system, in accordance with an embodiment of the present disclosure.

FIG. 2 schematically illustrates an exemplary switch, in accordance with an embodiment of the present disclosure.

FIG. 3 schematically illustrates an exemplary outlet, in accordance with an embodiment of the present disclosure.

FIG. 4 shows a flow diagram of an exemplary method, in accordance with an embodiment of the present disclosure.

FIG. 5 shows a flow diagram of an exemplary method, in accordance with an embodiment of the present disclosure.

FIG. 6 shows a flow diagram of an exemplary method, in accordance with an embodiment of the present disclosure.

FIG. 7 shows a flow diagram of an exemplary method, in accordance with an embodiment of the present disclosure.

FIG. 8 shows a diagram of an exemplary structure, in accordance with an embodiment of the present disclosure.

### DETAILED DESCRIPTION

Reference now will be made in detail to embodiments of the present disclosure, examples of which are illustrated in the accompanying drawings. Wherever possible, the same reference numbers will be used throughout the drawings to refer to the same or like parts and/or components.

### Overview

An automation system, e.g., a home automation system, generally may include one or more switches and one or more outlets (or other suitable power delivery components), with the user desiring which outlet or outlets are controlled by the switch(es). Existing X10 devices require the user to manually set an address on the switch and the outlet, an outlet would respond to a switch with an identical address enabling or disabling power to the outlet on command of the identically addressed switch.

Embodiments of the present disclosure include, among other things, an automation system. Examples of suitable systems include those described in U.S. application Ser. No. 13/672,534, filed Nov. 8, 2012, the entire disclosure of which is incorporated by reference herein. Systems according to the present disclosure may be used in, e.g., residential, commercial, and/or industrial structures. Non-limiting examples include single-family and multi-family dwellings, condominium units, apartments, apartment buildings, hospitals, cruise ships, offices, office buildings, schools, churches, sporting complexes, shopping centers, and manufacturing facilities.

The present disclosure may allow a user to add, remove, or relocate an appliance or other device coupled to an automation system while maintaining, adding, terminating, or modifying one or more function-based controls without the need for user intervention. Switches or other actuators of the automation system may be assigned functions, which may enable the system to appropriately associate the relevant appliances to their corresponding switches or actuators. Those of ordinary skill will understand that the reference to a “switch” or “switches” herein is intended to include any suitable actuator or actuators. For example, embodiments of the present disclosure may allow a user to unplug or otherwise disconnect the appliance from a first location and move it to a new, second location, wherein control over the appliance is adjusted based on the new location. For example, in one embodiment, control over the appliance may be maintained when it is plugged into a new outlet at the second location. The automation system may detect a change in the status of the appliance and map or associate the appliance to one or more switches without requiring the user to program or reprogram the switch(es).

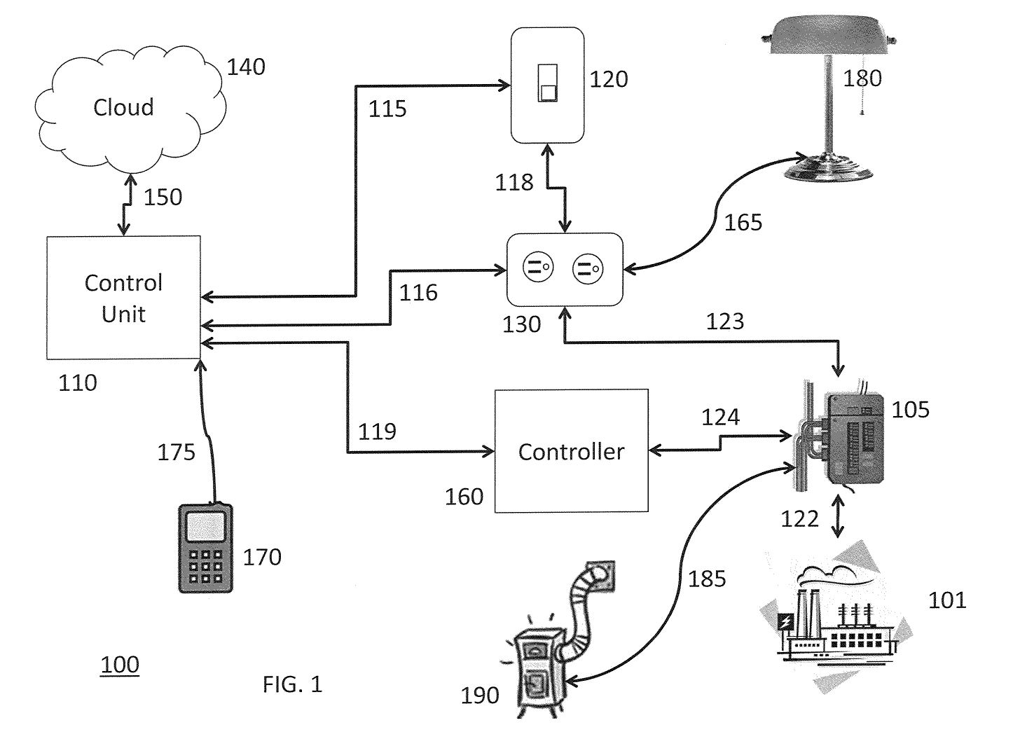

The present disclosure may be further understood with reference to FIGS. 1-8. In FIG. 1, for example, automation system 100 includes at least one outlet 130, which may be locally and/or remotely controlled. The outlet 130 may be configured to monitor the power consumed by one or more devices (e.g., appliances) connected thereto and/or control power delivered by the outlet 130. The system 100 further includes a switch 120, which may send a signal (e.g., a wireless signal) to a control unit 110. The control unit 110 also may be locally or remotely controlled and may include, for example, a computer with a microprocessor, memory, and user interface. The control unit 110 may be a discrete control unit, such as, e.g., a laptop, desktop, tablet, or any other suitable device. The control unit 110 may be connected via wired or wireless network connection 150 to the Internet cloud 140. The control unit 110 also may be connected to the switch 120 via wired or wireless connection 115, and further connected to the outlet 130 via wired or wireless connection 116. Similarly, the switch 120 may be connected to the outlet 130 via wired or wireless connection 118.

The system 100 may include one or more other components or enhancements. Referring to FIG. 1, for example, the automation system 100 may include a controller 160 that can control (e.g., adjust, open, close) window coverings. Controller 160 may be also configured to control other systems or enhancements associated with a home, office, school, or other structure. For example, controller 160 may control systems for irrigation, heating, cooling, entertainment, and/or water heating. In addition, controller 160 may control one or more safety systems. In embodiments where controller 160 may control window treatments, the controller 160 may receive instructions from the control unit 110 via wired or wireless connection 119. The switch 120 may also communicate with the controller 160, outlet 130, and/or one or more other components of system 100 via wired or wireless means (not shown). The wired or wireless connections, for example 115, 116, 118, and 119, may use the same or different protocols or standards. In some embodiments, switch 120 may communicate with outlet 130 through one or more devices of the system 100. For example, switch 120 may communicate with a second outlet (not shown) or other component of the system 100 through control unit 110, e.g., switch 120 may send a signal to control unit 110, and control unit 110 may send a signal to the second outlet. In some embodiments, switch 120 may send a signal to outlet 130, which may send a signal to the second outlet, thereby permitting communication between switch 120 and the second outlet. Other components of system 100 may similarly relay and/or send messages on behalf of a first component to a second component. This may be beneficial (in some cases required) if a direct communication path between the first and second components does not exist.

In addition to instructions being processed by control unit 110, some or all of the processing could be performed by one or more microprocessors included in the switch 120, the Internet cloud 140, or the outlet 130. It is understood that the system 100 may include multiple switches 120, outlets 130, and/or controllers 160, e.g., window control units. Other devices such as moisture sensors may be attached to the system 100 to provide information on the presence of water or rain. The outlet 130, switch 120, control unit 110, and controller 160 may include one or more features of the outlet, switch, control, and controller, respectively, described in U.S. application Ser. No. 13/672,534, filed Nov. 8, 2012, which is incorporated herein by reference in its entirety.

A mobile device 170 may be wirelessly connected to the system 100 via wireless connection 175. For example, the mobile device 170 may be connected to the control unit 110 as shown in FIG. 1, or may also be connected to the outlet 130, controller 160, switch 120, another device connected to the automation system 100, or any combinations thereof. The mobile device 170 may include a wireless transceiver, which provides means to measure received signal strength. The mobile device may include any suitable means of collecting, recording, analyzing, and/or transmitting data in order to locate, characterize, and/or otherwise identify one or more devices or components of an automation system. In some embodiments, for example, the mobile device 170 may include a heat sensor and/or an RF sensor. Further, in some embodiments, the mobile device 170 may include an imaging device, e.g., a camera, for taking and transmitting pictures. The mobile device 170 may include means for determining location and/or orientation information. Non-limiting examples of such technology include GPS, accelerometers, compasses, and gyroscopes. The mobile device 170 may collect data to determine the orientation of the camera when taking a picture, e.g., whether the camera is pointed towards a ceiling, a floor, or a wall. The geographic location and cardinal direction of the camera may also be determined via a compass, GPS, and/or other suitable data collected by the mobile device 170. In addition to instructions being processed by control unit 110, some or all of the processing could be performed by mobile device 170. Suitable methods of collecting and processing such information are described in U.S. application Ser. No. 13/766,123, filed Feb. 13, 2013, which is incorporated herein by reference in its entirety.

Further referring to FIG. 1, power may be generated at power plant 101, and transmitted to a home meter or breaker box 105 via, for example, wired transmission lines 122. The methods presently disclosed also may be applied to other utilities and/or alternative energy sources such as, e.g., water, natural gas, steam, heat, solar, wind, geothermal, algal, biomass, or any other utility or resource. Power may be routed to the outlet 130 by wires 123, and routed to controller 160 via wires 124. Power may be further routed to a heating ventilation and air conditioning (HVAC) system 190 via wire 185. It is also expected that power could be transmitted wirelessly and one or more of wires 122, 123, 124, and/or 185 could be replaced with wireless transmission methods. Each set of transmission wires, such as wires 123, may be referred to as a circuit. A circuit may, for example, be connected to and provide power to multiple devices, e.g., via multiple outlets 130. In some embodiments of the present disclosure, the system includes one or more circuits, e.g., circuit 123.

Breaker box 105 may measure voltage, current, and/or power on one or more power lines leading into and out of the breaker box 105. Breaker box 105 may, for example, include a utility meter. Breaker box 105 may be wired or wirelessly connected to automation system 100, and may include one or more sensors such as voltage meters, current meters, temperature sensors, or other types of sensors. The sensor(s) may be wired or wirelessly connected to the automation system 100.

An appliance 180 such as, e.g., a desk lamp, may be plugged into or otherwise operably coupled to an outlet 130 or other suitable power delivery component through connection 165, which may be wired or wireless. The appliance 180 may be able to communicate with system 100 and/or another entity, and the appliance 180 may have the ability to measure the amount of power drawn from outlet 130.

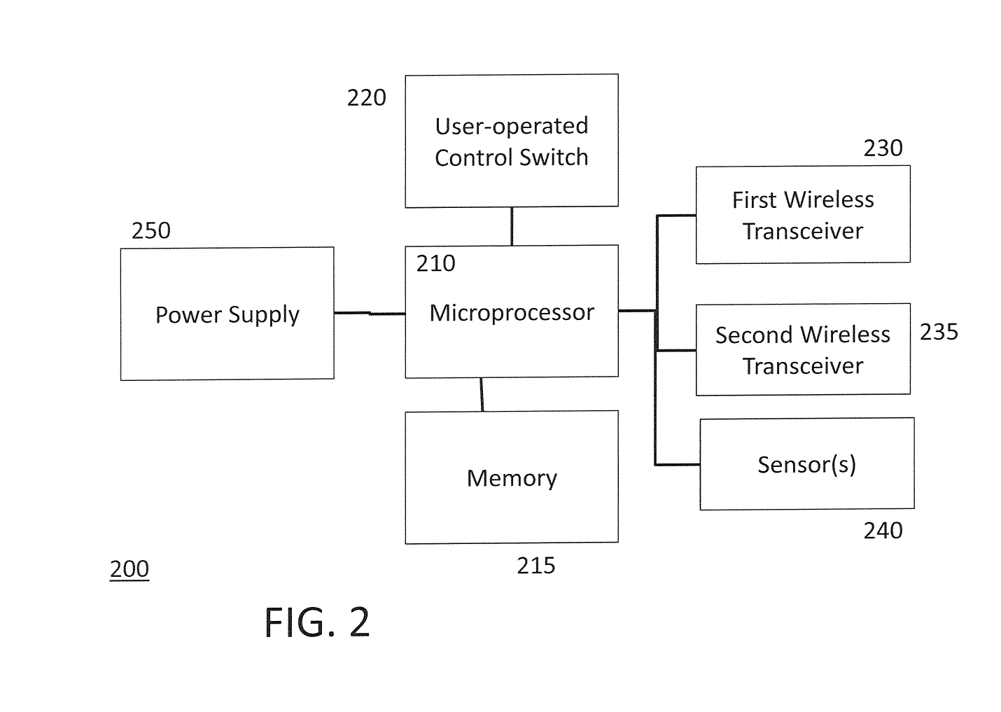

FIG. 2 shows a block diagram for a switch 200 that may be used in the automation system 100 and may operate as the switch 120 in FIG. 1. Switch 200 may be any suitable actuator known in the art. In at least some embodiments, the switch 200 is remotely controlled. The switch 200 may include a microprocessor 210 capable of running software or an algorithm stored in memory 215. Memory 215 may be, e.g., solid state or flash memory, or any other suitable type of memory. The switch 200 may include a user-operated portion 220, such as a mechanical light switch. In some embodiments, the switch includes one or more user input devices, including, for example, a touch sensor, a touch screen, and/or push buttons. User-operated portion 220 may be configured to control (e.g., interrupt, adjust, change, terminate and/or meter) the supply of energy to a device or an outlet (e.g., outlet 130 shown in FIG. 1) in communication with switch 200. In at least some embodiments, the user-operated portion is configured to control the supply of electrical energy to a device or outlet. Accordingly, in one embodiment, the user-operated control portion 220 may be configured to transition between an “on” position and an “off” position (i.e., supplying and terminating power, respectively). In another embodiment, the switch may allow various levels to be controlled by the user discretely or continuously (e.g., increasing or decreasing power supply).

The switch 200 may further include a first wireless transceiver 230, for example a 802.11 Wi-Fi transceiver. The term “transceiver” as used herein should not be construed as limited to any particular structural components. Instead, a transceiver may include any structural components configured to allow for back and forth communication, e.g., communication exchange. Accordingly, the transceivers disclosed herein may include, but are not limited to, antennae, power supplies, communication ports, and/or any other elements needed to achieve the desired function. The first wireless transceiver 230 may be configured to communicate over any known protocol including, but not limited to, X10, Zigbee®, and/or Bluetooth. Further, although the exemplary embodiment of FIG. 2 depicts the transceiver 230 as a wireless transceiver, those of ordinary skill will readily recognize that first wireless transceiver 230 may be replaced with a wired communication mode. First wireless transceiver 230 may allow the switch 200 to communicate with a control device, e.g., the control unit 110 as shown in FIG. 1. The first wireless transceiver 230 therefore may allow the switch 200 to exchange one or more commands with the control unit 110 of the automation system 100.

In some embodiments, the switch 200 may also include a second wireless transceiver 235 to allow the switch 200 to communicate with one or more devices (e.g., the outlet 130 shown in FIG. 1 and/or any electrical load coupled thereto) using multiple standards. Both transceivers 230 and 235 may include received signal-strength indicator means to identify the strength of a signal received by the transceiver. The first and second wireless transceivers 230, 235, respectively, may allow for communication over one or more protocols. In addition, the first wireless transceiver 230 may be configured to communicate over a protocol that is different from the communication protocol of the second wireless transceiver 235.

The switch 200 may include one or more sensors 240 configured to detect and/or respond to various conditions or stimuli, such as temperature, moisture (e.g., water, rain, or humidity), light, sound, air flow, contaminants, motion, or electromagnetic or radio frequencies. Examples of such sensors are disclosed in U.S. application Ser. No. 13/672,534, which is incorporated herein by reference. The switch 200 may include a power supply 250, which may be any suitable power supply known in the art. In some embodiments, for example, the power supply 250 includes a battery, e.g., a rechargeable battery. It is understood that the power supply 250 in FIG. 2 may schematically illustrate a wired or wireless connection to a power network, such as, e.g., a power grid or transformer. Further, the power supply 250 may include both a battery and a connection to a power network.

The switch 200 may include a microprocessor 210, which may be any suitable microprocessor known in the art. Although FIG. 2 shows the microprocessor 210 located within the switch 200, the microprocessor 210 may be remotely connected to the switch 200. The microprocessor 210 may be configured to communicate, e.g., exchange control signals, with the one or more sensors 240, the first wireless transceiver 230, the second wireless transceiver 235, and/or the user-operated portion 220.

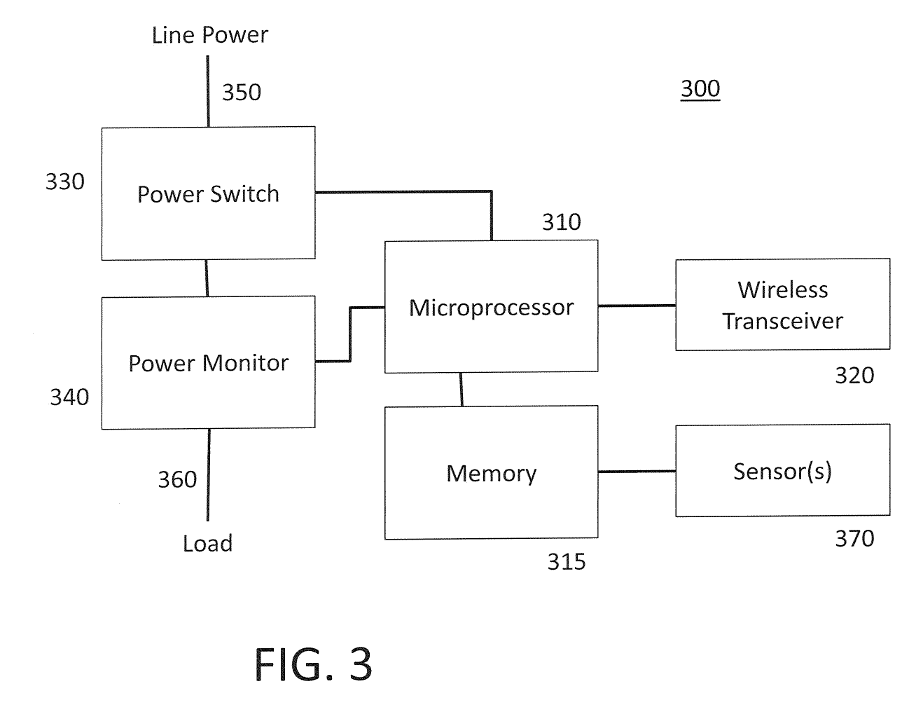

FIG. 3 shows a block diagram of an outlet 300 that may operate as the outlet 130 of the system 100 shown in FIG. 1. In at least some embodiments, the outlet 300 is remotely controlled. The outlet 300 may include a microprocessor 310 that runs software or an algorithm stored in memory 315. The microprocessor may be remote. The outlet 300 further may include a transceiver 320, which may include any of the features described in connection with transceivers 230 and 235 of FIG. 2. The outlet 300 also may include one or more sensors 370, which can include, e.g., motion sensors, voltage sensors, current meters, ambient light sensors, cameras, microphones, moisture sensors, or any of the sensors described above with respect to the one or more sensors 240 of FIG. 2. The sensors may allow at least one of the voltage and current to be measured at connection 350.

In some embodiments, the outlet 300 receives electrical energy via a power switch 330 supplied by line power via connection 350. The power switch 330 may be controlled by a microprocessor, e.g., 310, which may include any of the features described with respect to the microprocessor 210 of FIG. 2. The power switch 330 may be configured to connect or disconnect the line power to the outlet 300, including a connected load 360 (e.g., one or more electrical devices coupled to the outlet 300). The power switch 330 may also be configured to reduce a voltage or current delivered to the load 360, thus providing a dimming function.

The outlet 300 may further include a power monitor 340 for measuring the consumption of power by the load 360 connected to the outlet 300. The load 360 may be connected via any suitable means, such as, e.g., standard 2 or 3 pin power outlets, 220V outlets, or international standard outlets, and may also include a wireless connection such as via a wireless charger. The power monitor 340 may transmit measured power data to the microprocessor 310 via the transceiver 320, or may also transmit data to one or more other components or devices of the system 100.

In some embodiments, the power monitor 340 measures noise in the connection to the load 360 in order to determine the type of energy-consuming device(s) connected, e.g., as explained in U.S. application Ser. No. 13/672,534, which is incorporated herein by reference. This type of analysis is discussed, for example, in U.S. Pat. No. 8,094,034. Multiple connections throughout an entire structure may be monitored and analyzed to determine the types of devices, such as appliances, connected to define the load 360, e.g., by turning the devices on and off. In some embodiments, user activity may be inferred by monitoring a structure, e.g., identifying which loads are activated and deactivated. By monitoring power consumption characteristics of the load 360, one or more characteristics of a device connected to the outlet 300 may be determined, e.g., via techniques disclosed in U.S. Pat. No. 8,094,034 or other suitable analytical methods. Based on the power consumption characteristic(s), the device (e.g., an oven, refrigerator, fan, or other appliance) may be beneficially and intelligently identified.

In some embodiments, the outlet 300 may be connected to an appliance at 360 (i.e., an appliance as the load 360). The appliance may have a power switch similar to power switch 330 of the outlet 300 to turn the appliance on or off and/or to place the appliance in an intermediate state, such as dimming. The appliance power switch 330 may control power to the appliance, e.g., supply or disable power to the appliance. In some embodiments, the outlet 300 may monitor the state of the appliance to determine if the appliance power switch has been actuated. One method of determining actuation of the appliance power switch is to measure the resistance of the appliance, i.e., the resistance of the load 360 connected to the outlet 300. For example, a relatively small amount of electrical current or voltage may be supplied to the appliance and resistance measured, e.g., with an ohmmeter or other suitable device. If the appliance power switch is set to turn the appliance on, the appliance may present a relatively low impedance to the supplied current/voltage, whereas if the power switch is set to turn the appliance off, the appliance may present a relatively high impedance. By measuring the impedance of the load 360, the outlet 300 may determine the state of the appliance power switch and determine if the state of the switch has changed.

The outlet 300 may have electrical and/or mechanical capability of determining whether a plug is connected to the socket of the outlet 300. For example, the outlet 300 may include an electrical sensor and/or mechanical mechanism for detecting a connection or otherwise detecting the presence of a plug. Such sensors may include, but are not limited to, proximity sensors. Further, the outlet 300 may include an RF sensor for detecting an RF signal emitted by a plug in the plug is close to the outlet 300. Other suitable means of detecting and/or identifying whether an appliance or other device is connected to the outlet 300 will be known to those of ordinary skill in the art.

If the outlet 300 recognizes or detects a connection, e.g., determines that a plug is connected to the socket or detects a wireless connection to an appliance, the outlet 300 may monitor the state or condition of the appliance, e.g., whether the appliance is turned on or turned off. In some embodiments, for example, the outlet 300 may monitor the appliance continuously for a change in state.

In some embodiments, the outlet may monitor whether the appliance is turned on, turned off, or placed in an intermediate state if a person is determined to be in the vicinity of the appliance. For example, the outlet 300 may include a sensor 370 that may determine that a person is in the area of the appliance. Alternatively, or in addition, a sensor otherwise connected to the automation system 100 such as sensor 240 may determine that a person is in the area of the appliance. For example, a person may be in the same room as the appliance, in the same house or structure as the appliance, or within a certain predetermined distance of the appliance, such as, for example, from about 1-10 feet, e.g., within about 3 feet or 5 feet. The presence of a person may be determined by any suitable method, including, but not limited to, a motion sensor, a camera, or the presence of a mobile device, e.g., mobile device 170. In some embodiments, for example, the automation system 100 may determine the presence of a person by determining the location of a mobile device 170. In other embodiments, the automation system 100 may detect the presence of a person by detecting one or more other components of the system 100 being turned on, turned off, or otherwise adjusted in a given area. For example, the system 100 may detect a light being turned on and determine that a person is near the light. If no one is detected within the vicinity of the appliance, the outlet 300 may not conduct any monitoring, or may monitor the appliance periodically.

In some embodiments, for example, the outlet 300 may periodically check if the power switch on the appliance has been actuated. For example, the outlet 300 may monitor the appliance every 5 minutes, 10 minutes, 15 minutes, 30 minutes, 1 hour, 2 hours, 6 hours, 12 hours, or 24 hours, for a change in state. The periodicity may be adjusted depending on the time of day, the presence of a person, and/or other inputs to the automation system. For example, an outlet 300 may have an appliance plugged in, wherein initially power is not applied to the appliance. When the appliance is switched on, the outlet 300 may monitor the state of the appliance continuously, or the outlet 300 may monitor the state of the appliance periodically such as every 5 minutes. If a person is determined to be in the vicinity of the appliance and not moving, the outlet may, for example, monitor the appliance every 10 seconds. If the person in the vicinity of the appliance is moving, however, the outlet 300 may monitor the appliance every second.

If the outlet 300 does not determine that an appliance or other device is connected, e.g., plugged into the socket or otherwise connected wirelessly, the outlet 300 may not conduct any monitoring. The outlet 300 may periodically check to determine whether an appliance is connected, e.g., electrically and/or mechanically, as discussed above.

The outlet 300 may comprise a device that is included in a junction box or coupled to an electrical system, e.g., to provide power or another utility or device. By way of example, this could be a device included in a ceiling junction box that is coupled (e.g., wired) to a ceiling fan, a device included inline to power outside flood lights, a device that monitors and/or controls the flow of natural gas to a furnace, among other variations.

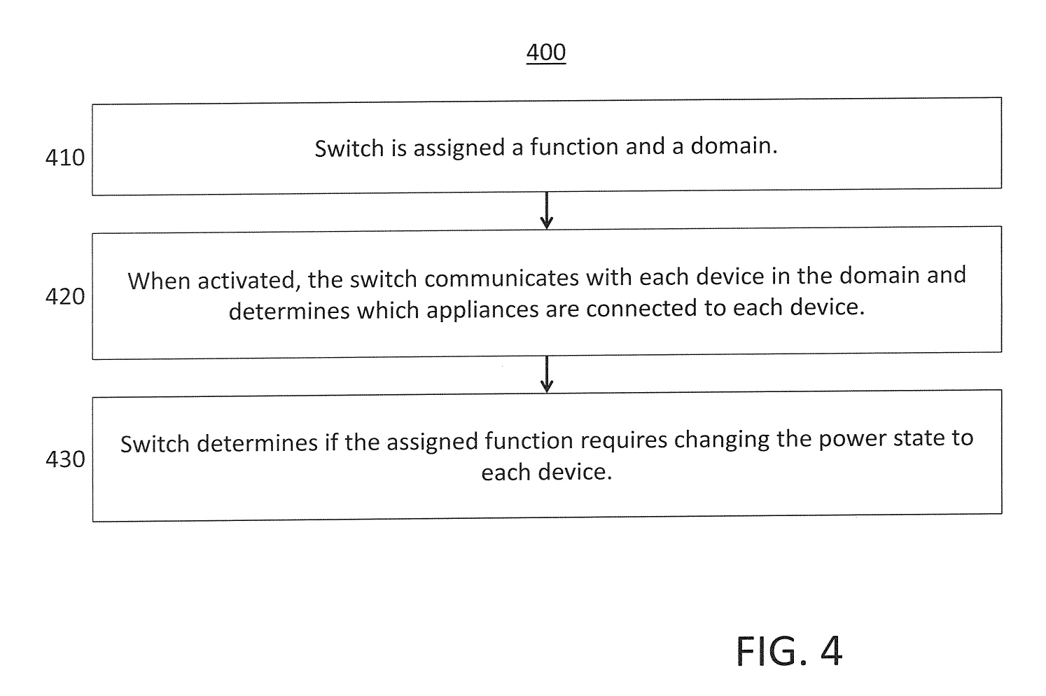

FIG. 4 illustrates an exemplary method 400 of determining which appliances to control when a switch is actuated, e.g., switch 120 in FIG. 1, which may be switch 200 in FIG. 2. The switch 120 may be assigned a function. Non-limiting examples include functions such as controlling lights in a room, opening the pool, leaving the house, returning home from school, etc. The function may be assigned by a user, e.g., an authorized user, or the automation system 100 may assign a function such as a default function to one or more switches 120.

In some embodiments, switch 120 may be assigned a function of disallowing or restricting usage of one or more outlets 130. The function may, for example, allow a switch 120 (or a domain of switches) to operate by providing power to one or more outlets 130 for a first period of time, such as 30 minutes, and then require that the switch 120 (or switches) terminate power to the outlet 130 for a second period of time, such as 60 minutes. In some embodiments, the function may restrict usage of one or more outlets 130 by increasing or reducing power, such as dimming. Further, for example, the assigned function may allow the switch 120 to provide power to classes of appliances (such as appliances related to a particular use, e.g., hedge clippers or an electric lawn mower associated with lawn maintenance), but restrict or not allow the switch to power one or more other appliances or outlets (e.g., a freezer or an outlet to recharge a car). This function may be particularly useful when used with a domain of all accessible outlets. All accessible outlets may include, for example, outlets outside the house, and may include outlets in the garage if the garage door is open. This feature would allow a homeowner to take a vacation, knowing that lawn maintenance service providers could still trim the hedges, but that a neighbor would not be able to run an extension cord and plug into the homeowner's house to recharge the neighbor's car.

One or more components of the automation system 100 may be mapped to a location via any suitable method, such as those described in U.S. patent application Ser. No. 13/766,123, entitled SYSTEMS, DEVICES, AND METHODS FOR MAPPING DEVICES TO REALIZE BUILDING AUTOMATION AND ENERGY MANAGEMENT, the disclosure of which is incorporated by reference. In some embodiments, at least one device, for example a plurality of devices, may be mapped to a location by the automation system 100. One or more switches 120 of the automation system 100 then may be assigned default functions. For example, by default, a first switch 120a in a room may be assigned the function of controlling one or more lights, a second switch 120b may be assigned the function of controlling one or more outlets 130, and a third switch 120c may be assigned the function of controlling temperature.

When a switch 120 is assigned to a controlled device such as, for example, an outlet 130, the assignment also may be referred to as the switch 120 being mapped, associated, or linked to the outlet 130, or added to a list or profile within the automation system 100 that identifies domain-based and/or function-based associations among components of the automation system 100. All of these terms describe control signals from the switch 120 resulting in an action by the controlled device, e.g., outlet 130. A profile may include a list or file stored in a server connected to the Internet cloud 140 or may be stored in one or more components of system 100 such as the control unit 110, controller 160, mobile device 170, or another component of system 100. A profile may include any information related to system 100. A profile may, for example, include information on associations among different components of system 100, such as current associations, past associations, dynamic associations, and/or proposed associations, e.g., planned associations. The profile may include information on utility usage, such as, for example, current usage, historical usage, proposed usage, projected usage, usage by room or domain, or usage by person or user. The profile may include a list of authorized users, and may indicate which users can authorize which functions. The profile may include known, expected, and/or projected information for a device or devices in system 100 or otherwise in communication with system 100. For example, the profile may include information on a HVAC system and/or information on one or more appliances that are, or may be, attached to the system 100.

In step 410, the switch 120 may be assigned a function and also may be assigned a domain or set of devices that the switch 120 may control. The domain may include the area over which the switch 120 will control different devices, e.g., appliances. Possible domains include, but are not limited to, specific rooms, e.g., the room in which the switch 120 is located; an apartment; an entire house; a floor of a house, building, or office; outside of a structure; a basement; all outlets within 3 feet of the floor; etc. The domain may be assigned by a user, such as an authorized user, or the domain may be assigned by default by a component of the automation system 100. Domains also may be determined or assigned by a type of device. For example, a domain may include entertainment devices (e.g., a television, Blu-ray Player, etc.), small appliances (e.g., a toaster, a coffee maker, etc.), or cleaning appliances (e.g., a dishwasher, a washer-dryer, etc.). Domains may also be dynamic. For example, a domain may include “all bedrooms that are occupied.” In a family with parents and children, a parent could actuate one switch with the function “all bedrooms that are occupied” to turn on bedroom lights for any occupied bedroom. If one child is away at a camp and not home, his lights would not be turned on. Other examples of dynamic domains may include, for example, the room in which a designated user is located, rooms with sunlight, rooms with guests, etc.

In step 420, the switch 120 may be actuated, e.g., turned on. In some embodiments, the switch 120 may communicate with every device (e.g., any device within system 100 that may be controlled, such as outlet 130, controller 160, or any other device in communication with automation system 100) in the domain and determine which devices have appliances or other devices attached. For example, the switch 120 may communicate with a door lock, a valve (e.g., a gas valve, water valve, heater valve, pressure valve, etc.), a garage door opener, or other device in communication with the system 100. A list of possible devices such as outlets 130 and appliances that are in the domain of the switch 120 may be created. The list may be created and/or stored one or more ways such as, e.g., in the control unit 110 of system 100, a mobile device 170, a server connected to the Internet cloud 140, within the same and/or another switch 120 of system 100, or in any other component connected to or otherwise in communication with automation system 100 that contains a microprocessor. In some embodiments, the list may be displayed on a suitable display, such as a display with a user interface.

In step 430, the system 100 may determine if the function or effect assigned to the switch 120 requires changing the power state to one or more outlets 130 or other devices in the domain, e.g., supplying or terminating power to the outlet (s) 130 or device(s). The determination may be performed, for example, in the Internet cloud 140, or via the control unit 110, mobile device 170, a switch 120, an outlet 130, and/or by another component connected to or otherwise in communication with system 100. In some embodiments, the determination may be made by a combination of components of the automation system 100. For example, if the function of the switch 120 is to control lights, the system 100 may determine which devices in the domain are lights or are connected to a light, and all identified devices would be controlled by the switch 120.

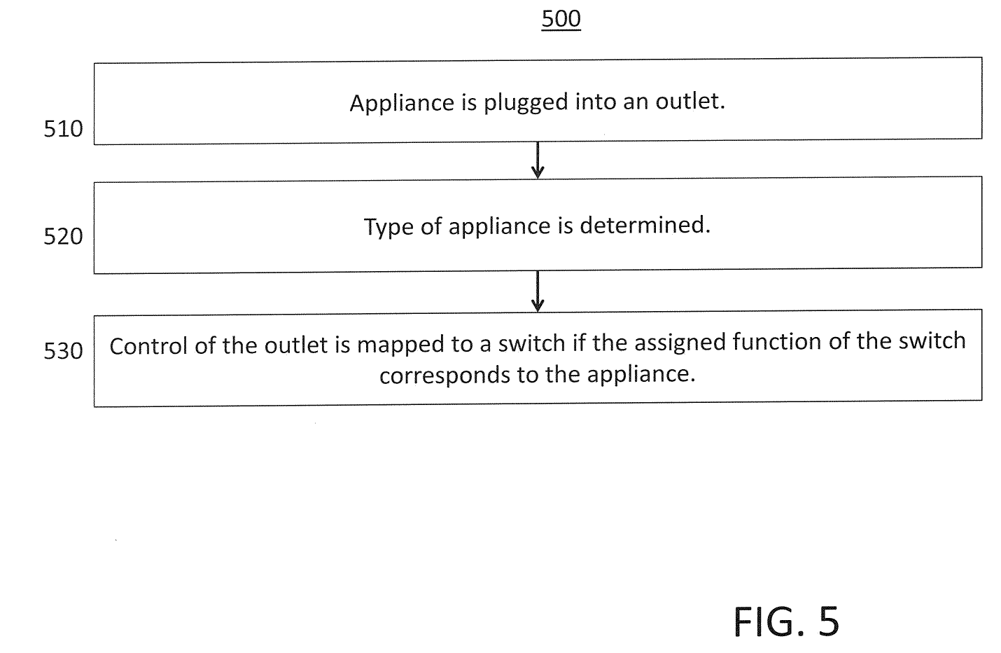

FIG. 5 illustrates an exemplary method 500 of maintaining a list of associations among devices, e.g., outlets 130, and devices/appliances as the devices/appliances are plugged into the outlets 130. In step 510, an appliance is plugged into an outlet 130. In some embodiments, the appliance or device may be connected to a power grid or other power supply. Further, step 510 may include connecting a battery-operated device/appliance to the automation system 100, e.g., via a wireless or wired connection.

In step 520, the type of appliance is determined. The type of appliance may be determined by communication between the appliance and one or more components of the automation system 100. For example, the type of appliance may be determined from one or more characteristics of the appliances, such as the power drawn by the appliance, or a noise from the appliance generated as discussed above.

In step 530, the identified appliance may be compared to the functions and domains of switches 120 within system 100. If the function of an appliance is related to the function of a switch 120, then control of the appliance may be mapped (e.g., associated or assigned) to actuation of the switch 120. In some embodiments, associating the appliance to the switch 120 may require the appliance to be in the domain of the switch 120. Thus, if an appliance is plugged into a controllable outlet 130 in an automation system 100, the appliance would be identified, and then assigned to a switch 120 for control, if appropriate. This may be advantageous because there is no interaction required by the user to assign the new appliance to a switch 120.

In some embodiments, the automation system 100 may maintain (e.g., create and/or store) a list of appliances that are mapped or associated with select switches 120 (e.g., via direct association or appliances associated via outlets 130 to which they are connected). In other embodiments, outlets 130 may respond to commands of a switch 120 sent over the automation system 100 without the need for a list.

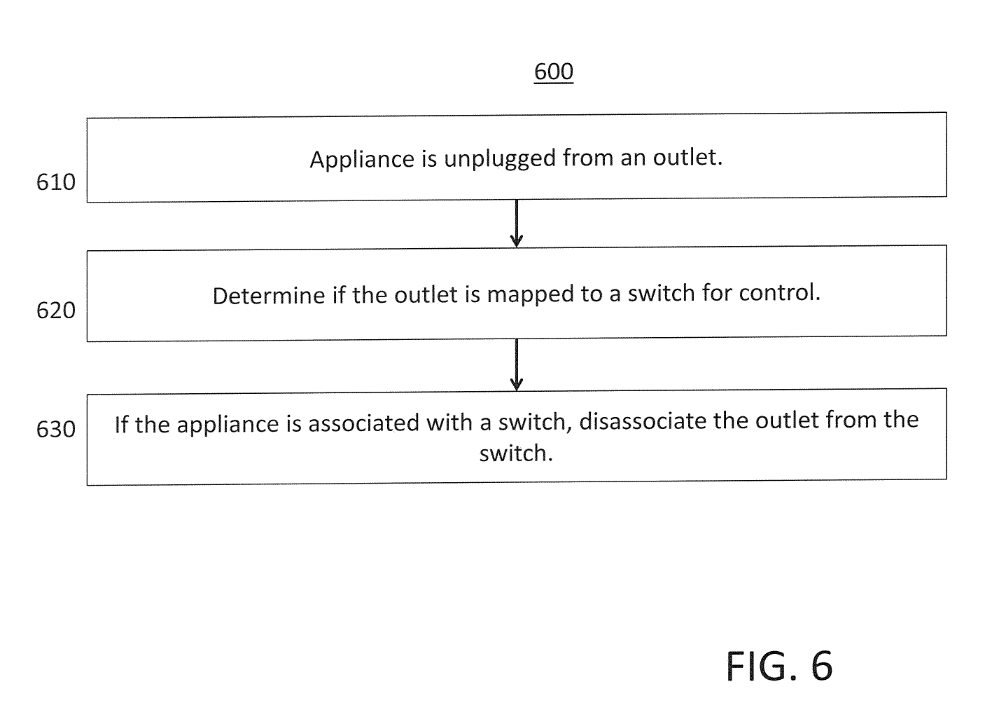

FIG. 6 illustrates an exemplary method 600 of adjusting to an appliance or device that is unplugged from an outlet 130 or otherwise becomes unavailable to the system 100. In step 610, an appliance may be unplugged or otherwise disconnected from an outlet 130 or other power source. For example, a battery-powered appliance may be disconnected from the outlet 130 by turning off or having a dead battery.

In step 620, the system 100 may determines if the outlet 130 is mapped to a switch 120. The determination may be made, for example, by the control unit 110, a switch 120, and/or another component connected to the automation system 100.

In step 630, the outlet 130 that the appliance was plugged into may be disassociated from the switch 120. For example, if the switch 120 is actuated, it will no longer control the outlet 130 that the appliance was plugged into. This step may involve the outlet 130 no longer responding to control signals from the switch 120, or may include removing the outlet 130 or appliance from a list of associated components within the automation system 100. In some embodiments, however, the outlet 130 may not be disassociated from the switch 120 if, for example, another appliance is plugged into the outlet 130. The system 100 may determine whether any other devices are connected to the outlet 130 before disassociating the outlet 130 from the switch 120. Further, the particular outlet 130 may be associated with another switch 120 or actuator.

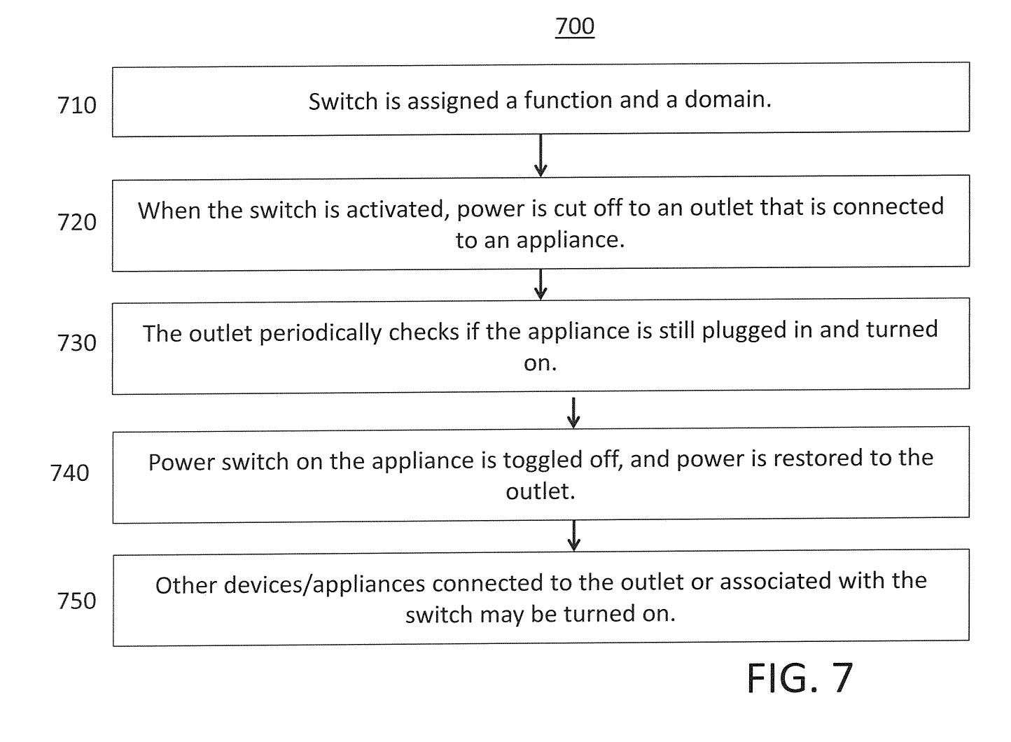

FIG. 7 illustrates an exemplary method 700 of controlling devices in an automation system 100. In step 710, a switch 120 may be assigned a domain and a function or effect. When the switch 120 is activated in step 720, power may be cut off or otherwise temporarily or permanently disabled to at least one outlet 130 or other device. The device may be an outlet, such as outlet 130 of FIG. 1 or outlet 300 of FIG. 3, which may have an appliance attached. For example, the switch 120 may be assigned a function of minimizing energy use, or of terminating or otherwise reducing (without terminating) power to one or more outlets within a home, office, or other structure as part of a safety feature.

In step 730, the outlet 130 may determine if the appliance is still connected and may determine if the power switch on the appliance is turned on. The outlet 130 may monitor for attached appliances, e.g., as described above in connection to FIG. 3. When the outlet 130 does not have a continuous supply of power, monitoring may be done by mechanical means and/or by enabling a small voltage on the outlet periodically.

When the power switch on the appliance is turned off, the outlet 130 connected to the appliance may detect actuation of the power switch. The outlet 130 may determine that the appliance is no longer turned on, for example, by detecting a change in impedance or by other means known in the art.

In step 740, power may be restored to the outlet 130 as a result of a user turning off the power switch on the appliance. For example, the system may include an override feature wherein automatic control over the outlet 130 by the switch 120 may be circumvented by one or more non-automatic commands such as a user turning on a power switch of an appliance. Thus, if the user turns the power switch of the appliance back on, the appliance will function since power has been restored to the outlet 130.

In step 750, a component of the automation system 100 may detect that the user has turned on a particular appliance. The automation system 100 may turn on other devices or appliances, e.g., within the same domain, as a result of a user turning the particular appliance on. For example, the system may turn on other devices associated with the same function and/or within the same vicinity.

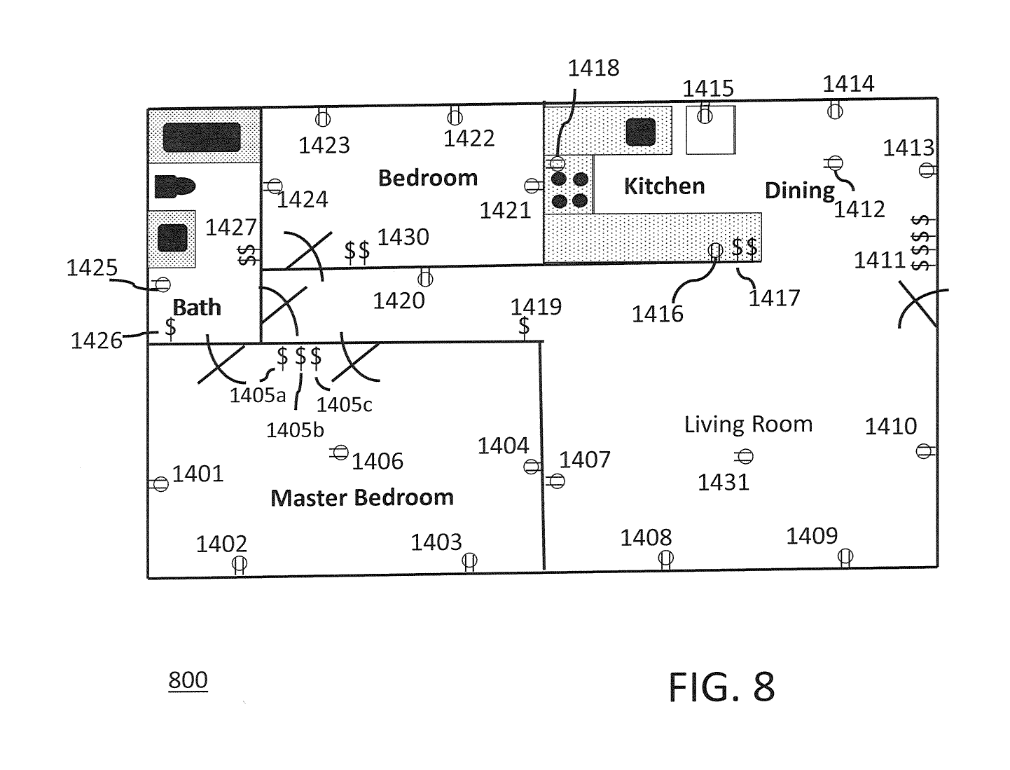

FIG. 8 illustrates a floor plan of an exemplary 2-bedroom apartment 800 that includes an automation system 100. The apartment includes a kitchen, a dining room, a living room, a bedroom, a bath, and a master bedroom. The master bedroom may include four outlets 1401, 1402, 1403, and 1404 along the baseboard, for example. A ceiling fan may be connected to one socket of outlet 1406, and a ceiling light may be connected to a second socket of outlet 1406. In some embodiments, an outlets may have more then one socket. Individual sockets of an outlet may be individually controlled. The terms “socket” and “outlet” may be used interchangeably to indicate that a single socket of a multi-socket outlet may be controlled by a switch/actuator.

The master bedroom also includes a set of three wall-mounted switches 1405 (e.g., switches 1405a, 1405b, and 1405c). Each switch within set 1405 may be mapped to a function, e.g., a function of controlling lights (switch 1405a), a function of controlling outlets (switch 1405b), and a function of controlling temperature (switch 1405c). The function of the switches 1405 may be fixed or may be dependent on one or more parameters such as time, date, season, weather, the type of device (e.g., a type of light or fan), the person actuating the switches 1405, and/or the presence of persons other than the person actuating the switches 1405. The functions of the switches 1405 may be assigned by default, or may be assigned by a user such as an authorized user, the control unit 110, another component of the automation system 100, or an authorized server connected to the Internet cloud 140.

The switch 1405a assigned the function of controlling lights may be automatically mapped to a light connected to the socket of outlet 1406. A person may add a floor lamp or a lamp on a table, for example, to the master bedroom, and may plug the lamp into a socket of outlet 1402. The identity of the appliance as a light, including any details regarding the type, brand, and/or model of the light, may be determined as discussed above, and since the lamp falls under the function of the lights switch 1405a, the socket of 1402 may be mapped to the switch 1405a, which is assigned the function of lights. A list or profile maintained within the automation system 100 may be updated to include at least the socket of outlet 1402 to which the lamp is connected, or the outlet 1402 may be programmed to respond to the switch 1405a with the function of light control, or the outlet 1402 may be associated or mapped to the switch 1405a by another means known in the art. Actuating the light switch 1405a therefore may control the ceiling light connected to outlet 1406 and the lamp connected to outlet 1402. If the lamp is unplugged, however, the association between the outlet 1402 and the light switch 1405a may be broken. It is expected that each socket of outlets 1401, 1402, 1403, 1404, etc., may be individually controlled. In at least one embodiment, only the socket that has a light plugged into it may be mapped to switch 1405a assigned the function of lights.

A switch with the function of controlling outlets, e.g., switch 1405b, may turn the power on and off to one or more outlets in the domain, such as within the master bedroom. To continue the example described above, if the lamp is connected to outlet 1402, that outlet 1402 may or may not continue to also be controlled by the outlet switch 1405b. That is, when the outlet 1402 is assigned to the light switch 1405a, whether or not the outlet 1402 remains assigned to and controlled by the outlet switch 1405b may depend upon preferences in at least a part of the automation system 100, such as, for example, the control unit 110, a server connected to the Internet cloud 140, or a switch 120. If the lamp is unplugged from outlet 1402, at least that socket of outlet 1402 may be remapped to the switch 1405b with the function of controlling outlets.

As another example, a lamp may be connected to outlet 1402, wherein outlet 1402 had been mapped to switch 1405b with the function of controlling outlets. If the outlet 1402 receives commands from the switch 1405b to not provide power when the lamp is plugged in, the outlet 1402 may or may not detect the lamp. For example, the outlet 1402 may detect the lamp by periodic or continuous monitoring as described above, or may not detect the lamp until switch 1405b with the function of controlling outlets is actuated and power is supplied to the lamp. At that time, the identity of the lamp may be determined and the socket of outlet 1402 to which the lamp is connected may be mapped to switch 1405a with the function of controlling lights. Plugging an appliance into an outlet that is not turned on and providing power may delay the identification of the appliance and the mapping of the outlet to the appropriate switch(es). Further, if the lamp turns on when the outlet controlling switch 1405b is activated, the light controlling switch 1405a may then activate the other lights in the domain. Outlet 1402 may be assigned to both light-controlling switch 1405a and outlet-controlling switch 1405b, or may be unmapped from outlet-controlling switch 1405b, i.e., only assigned to light-controlling switch 1405a.

In some embodiments, the automation system may determine a priority status of an appliance or other device and supply and/or terminate power based at least in part on that priority status. For example, if an alarm clock is plugged into outlet 1401 of the master bedroom, the automation system 100 may identify the alarm clock and determine that power should not be interrupted to the alarm clock. Thus, the association between the socket of outlet 1401 to which the alarm clock is connected and outlet-controlling switch 1405b may be broken. Power to the alarm clock may be sustained and uninterrupted. Should the alarm clock be unplugged, the socket of outlet 1401 may be remapped, e.g., to the switch 1405b with the function of controlling outlets.

A switch may have the function of adjusting temperature, e.g., switch 1405c mentioned above. If the switch 1405c is actuated to decrease the temperature, outlet 1406 may be controlled to activate the ceiling fan at a corresponding rate, e.g., a fast rate or other desired setting, to create a breeze. If a floor fan is plugged into outlet 1404, the fan may be identified and outlet 1404 may be associated with temperature switch 1405c so that both the ceiling fan and floor fan are controlled. If the outlet 1404 had been assigned to outlet-controlling switch 1405b before the floor fan was plugged in, the association between outlet 1404 and switch 1405b may be broken while the fan is plugged into outlet 1404. Further, activating the temperature-controlling switch 1405c to decrease the temperature may result in adjustments to the HVAC system to reduce the temperature, e.g., by reducing the heat or increasing air conditioning, and may cause controls within the vents to reduce the flow of heated air or increase the flow of air conditioned air to the master bedroom. If temperature switch 1405c is actuated to increase the temperature, switch 1405c may, for example, control the ceiling fan and/or the floor fan to run at a corresponding rate, e.g., a slow rate or other desired setting, to circulate air without creating a breeze. The HVAC may receive commands from switch 1405c requesting more heat or less air conditioning, and controls in the vents may be adjusted to increase the heat flow or decrease the flow of air conditioned air into the master bedroom.

In some embodiments, the system 100 may include an override feature. For example, a switch 1411 within a set of four switches may be assigned to control lights in the living room, such as a ceiling lamp connected to outlet 1431, a lamp on an end table connected to outlet 1407, and a floor lamp plugged into outlet 1409. Other switches within the same set as 1411 may be assigned to other functions, e.g., controlling outlets, temperature, locks on doors and/or windows, entertainment devices, lights in another room, outside lights, etc., and may control other devices, e.g., connected to outlets 1408, 1410, 1412, 1413, and/or 1414. Further, switch 1411 may be assigned one or more functions other than controlling lights, and thus control one or more devices connected to other outlet(s) in the living room or another domain, e.g., the bath, bedroom, kitchen, dining room, master bedroom, or even another apartment and/or devices outside the apartment 800.

The light-controlling switch 1411 may be assigned the function of minimizing power usage by cutting power to lights when the light controlling switch 1411 is activated. Thus, if a person actuates the living room light switch 1411, the sockets of outlets 1407, 1409, and 1431 connected to lights may discontinue providing power.

Activating a power switch on the light may restore power, however, and allow the light to be turned on without activating light-controlling switch 1411. For example, a user sitting in a chair near outlet 1407 may turn the power switch of the lamp connected to outlet 1407 off. The outlet 1407 may detect the change in the load, e.g., by measuring impedance of the lamp at outlet 1407, and the switch 1411 may restore power to the outlet 1407. Thus, if the user activates the lamp power switch to turn the lamp on, the lamp may power up. The user therefore may override the light-controlling switch 1411 across the room without having to leave his chair. When the outlet 1407 detects the lamp powering on, the automation system may turn on other lights within the same domain. The lights in the domain for this example include the ceiling lamp connected to outlet 1431, the floor lamp connected to outlet 1409, and the lamp connected to outlet 1407. When the lamp turns on, outlet 1407 may detect the flow of electrical power to the appliance. Outlet 1407 may determine that the lamp's function is related to switch 1411, and may communicate with switch 1411 or another component of system 100 to indicate that the lamp was turned on. Because switch 1411 has the function of controlling lights, within the domain of the living room, switch 1411 may control the other appliances or devices, e.g., within its domain, to cause the rest of the lights commanded by switch 1411 to also turn on. The function of turning on the rest of the domain of lights may be executed by another device in system 100 such as, for example, the control unit 110, an authorized server in the Internet cloud 140, or the outlet 1407.

In a variation of the previous example, the system may detect that a user has actuated a power switch on a device such as a light, and turned the light off. If the user then actuates the power switch to turn the light on, power may be restored to the socket the light is plugged into. Power therefore may be restored, allowing the user to turn a light on by actuating the power switch of the light off and then on without activating a switch in another location, e.g., a power switch on the wall. Further, the socket may not be re-energized until the user signals a desire to have the light on by actuating the power switch of the light.

In another example, the automation system may determine that an appliance connected to outlet 1409 was turned on. This association may be compared to a list or profile, e.g., stored within system 100 or otherwise accessible to system 100, to determine that the appliance may be controlled by switch 1411. The automation system may communicate with switch 1411 to indicate that a light was turned on, and switch 1411 may send commands to other devices that may be in the domain of switch 1411 to also turn on. Switches and outlets in other rooms of apartment 800 shown in FIG. 8 may operate similarly as those described above in connection to the master bedroom and/or living room. For example, the bath includes switches 1426 and 1427 and an outlet 1425; the bedroom includes switches 1430 and outlets 1421, 1422, 1423, and 1424; the kitchen includes switches 1417 and outlets 1415, 1416, and 1418; and the hallway includes switch 1419 and an outlet 1420. As mentioned above, the domain may, but need not, include devices in the same room. Thus, outlet-controlling switch 1405b in the master bedroom may control one or more outlets in the kitchen, e.g., to turn a coffee maker on or off according to a “wake up” function, and/or one or more outlets in the living room, e.g., to turn a television on or off according to a “go to bed” function.

Further, as mentioned above, switches and/or outlets according to the present disclosure may, but need not be, fixed to a particular location. In at least some embodiments, connections between any of the components of the automation system may be wireless and/or remote controlled. For example, a user may have a mobile device 170 that allows the user to activate a switch with a particular function from a remote location, e.g., to control home devices while at work or on vacation. For example, a person may have forgotten to turn off an air conditioning unit at home while on vacation, and use his/her mobile device to activate a switch assigned a security or emergency function to terminate or otherwise adjust power (e.g., increase or reduce power such as a dimming function) to particular devices, such as temperature-related appliances.

Further, according to some embodiments of the present disclosure, adding, moving, or removing a device from the automation system will not disrupt assigned functions. For example, if a child returns home after school with a new entertainment device, the automation system may detect and identify the new device, and associate the new device to a switch with a related function, e.g., a switch assigned to control entertainment devices. Thus, if the child is not allowed access to entertainment devices within a particular time period, the system may not provide power to the new entertainment device within that time period without any input required from the child's parent.

Other function-based controls according to the present disclosure may include, but are not limited to: an emergency or panic function (e.g., locking all doors and/or windows, closing garage doors, activating an alarm, turning on all lights inside and/or outside of a structure, etc.), an “all off” function (e.g., terminating power to all outlets, or terminating power to all outlets without priority status such as, e.g., powering a refrigerator or home alarm system), a vacation function to save energy while away from a home or business (e.g., terminating power to all non-essential devices, adjusting a level of power to one or more devices to reduce energy consumption, controlling temperature-related devices to minimize unnecessary heating or cooling), as well as other functions such as opening and/or closing a covering, such as a covering to a swimming pool, a garage door, a roof, or a window; a function associated with leaving the house (e.g., locking doors, turning of select appliances), retiring for the evening (e.g., locking doors, turning off lights, turning off the television), etc.

In some embodiments, the system 100 may include a manual mode that allows a person to adjust one or more devices such as a light without having the automation system 100 attempt to control other devices as a result. For example, a user may want only a subset of lights turned on without affecting other lights or devices within the system 100. The manual mode may involve a voice command, and/or entering a command via a device in communication with system 100, such as, for example, control unit 110, mobile device 170, an outlet 130, or a switch 120.

In some embodiments, a person may install a series of appliances in a structure such as a home, an office, or a department store, where the appliances may be holiday or seasonal lights and/or other decorations or ornamentation. For example, the appliances may include lights (e.g., Christmas lights or electronic candlelight), animated dolls (e.g., Santas, elves, reindeer, Halloween monsters, and the like), music players (e.g., an mp3 device or a store intercom system), or other entertainment appliances. The automation system 100 may automatically detect a series or class of one or more appliances being plugged in or otherwise connected to the system 100, and may associate all of the lights and decorations to one function for centralized control. The lights and decorations may be placed in multiple rooms, and may be inside or outside the structure. Further, in some embodiments, the automation system 100 may have a record of lights and decorations that were installed previously, and may use this information to assist in identifying lights and decorations. For example, the system 100 may have a profile that includes information on holidays lights and decorations that were previously installed, such as the types of appliances installed, their locations, their energy use characteristics, and/or times of the day or days of the week the appliances should operate.

In some embodiments, a user may inform the automation system that lights and decorations have been installed, will be installed, or are being installed. The automation system may detect, identify, and/or analyze the appliances and determine whether the appliances are decorations, and assign the applicants to an appropriate function. The function of controlling the lights and decorations may be assigned to a single switch, allowing all of the appliances in a structure to be centrally controlled.

Other embodiments consistent with the disclosure herein will be apparent to those skilled in the art. For example, when an appliance is manually turned on or turned off, the automation system 100 may respond by adjusting power to one or more other devices that are determined to have the same function as the appliance. The other device(s) may be members of the same domain as the appliance that was manually turned on or turned off.

It is understood that the present disclosure is not limited to the particular forms, embodiments and examples illustrated. The method and apparatus of the disclosure can be practiced with and modifications and variations that do not depart from the spirit and scope of the disclosure.

Embodiments of the present disclosure may be used in connection with any structure, including, but not limited to, homes, offices, businesses, schools, churches, sporting complexes, hospitals, shopping centers, and manufacturing facilities. In addition, at least certain aspects of the aforementioned embodiments may be combined with other aspects of the embodiments, or removed, without departing from the scope of the disclosure.

Other embodiments of the present disclosure will be apparent to those skilled in the art from consideration of the specification and practice of the embodiments disclosed herein. It is intended that the specification and examples be considered as exemplary only, with a true scope and spirit of the disclosure being indicated by the following claims.

We claim:

1. An automation system, comprising:
at least one actuator;
at least one device selectively controlled by the actuator; and
at least one appliance operably coupled to the at least one device;
wherein the actuator is assigned at least one function, the actuator being configured such that when the actuator is actuated, the automation system determines if the appliance is related to the assigned function, and adjusts a supply of power to the device if the appliance is related to the assigned function.

2. The automation system of claim 1, wherein the at least one device is configured to terminate power to the at least one appliance.

3. The automation system of claim 1, wherein a first device is included in a first domain of devices and a second device is included in a second domain of devices, wherein:
the actuator is assigned to the first domain such that the actuator selectively adjusts a power supply to the first device and to any other device within the first domain of devices.

4. The automation system of claim 3, wherein at least one of the first domain or the second domain includes a plurality of devices, wherein each device of the plurality of devices is located in a room, in a group of at least two rooms, in a level of a multi-level structure, completely outside a structure, completely inside a structure, or within a predetermined distance of a wall of a structure.

5. The automation system of claim 4, wherein the wall of the structure includes the floor.

6. The automation system of claim 1, wherein the at least one device is an outlet.

7. The automation system of claim 1, wherein the at least one assigned function of the actuator includes controlling at least one light, adjusting a temperature, controlling the at least one device, opening a covering, or closing a covering.

8. The automation system of claim 7, wherein the at least one assigned function of the actuator includes controlling a plurality of lights such that activating the actuator causes all lights within the first domain to turn on.

9. The automation system of claim 7, wherein the at least one assigned function of the actuator includes controlling at least part of two devices located in different rooms of a structure.

10. The automation system of claim 7, wherein the at least one assigned function of the actuator includes controlling at least two devices, wherein a first device is located inside a structure and a second device is located outside a structure.

11. The automation system of claim 7, wherein the covering includes a garage door, a roof, a window, or a covering to a pool.

12. The automation system of claim 1, wherein the at least one actuator is in wireless communication with the at least one device.

13. The automation system of claim 1, further comprising at least one mobile device in wireless communication with the actuator, wherein the at least one mobile device is configured to actuate the actuator remotely.

14. The automation system of claim 1, comprising
a plurality of actuators, each actuator being assigned at least one function;
a plurality of devices, each device being selectively controlled by at least one actuator; and
a plurality of appliances, each appliance being operably coupled to a device;
wherein the automation system further comprises a profile of assignments among each of the actuators, devices, and appliances.

15. The automation system of claim 14, wherein the assigned function of each actuator differs from the assigned functions of the remainder of the plurality of actuators.

16. The automation system of claim 14, wherein a first appliance is assigned to a first actuator and a second actuator, and wherein a second appliance is assigned to the second actuator.

17. The automation system of claim 16, wherein changing a power state of the first appliance causes a change in power state of the second appliance.

18. The automation system of claim 17, wherein changing the power state of the first appliance includes manually adjusting the first appliance.

19. A method of controlling devices in an automation system, the method comprising:
assigning at least one actuator of a plurality of actuators a function and a domain;
connecting a first appliance to a first outlet in communication with at least one actuator of the plurality of actuators;
determining if the first appliance is related to the assigned function and domain of each actuator in communication with the first outlet; and
if the first appliance is related to the assigned function of at least one actuator in communication with the first outlet, controlling a supply of power to the first outlet with the related at least one actuator.

20. The method of claim 19, where determining if the first appliance is related to the assigned function and domain of each actuator includes determining an identity of the first appliance by analyzing a power consumption characteristic of the first appliance.

21. The method of claim 19, further comprising:
connecting a second appliance to a second outlet in communication with at least one actuator of the plurality of actuators;
determining if the second appliance is related to the assigned function and domain of each actuator in communication with the second outlet, and, if the second appliance is related to the assigned function at least one actuator;
controlling a supply of power to the second outlet with the at least one actuator.

22. The method of claim 19, wherein controlling the supply of power to the first outlet includes providing power, terminating power, increasing an amount of power, or decreasing an amount of power without terminating delivery of power.

23. The method of claim 22, wherein the at least one actuator terminates power to the first outlet, the method further comprising:
detecting a change in a power state of the first appliance; and
restoring power to the first outlet.

24. The method of claim 23, wherein the power state of the first appliance is changed by actuating a power actuator of the first appliance.

25. The method of claim 23, wherein detecting the change in power state of the first appliance includes measuring electrical impedance.

26. The method of claim 23, further comprising restoring power to a second outlet.

27. The method of claim 26, wherein a second appliance is operably coupled to the second outlet.

28. The method of claim 28, wherein the first appliance and the second appliance are included in the same domain.

29. The method of claim 23, further comprising restoring power to a plurality of devices of the automation system.

30. The method of claim 19, wherein the first outlet is assigned to a first actuator, and disconnecting the first appliance from the first outlet dissociates the first outlet from the first actuator.

31. A method of controlling devices in an automation system, wherein the automation system comprises:
a plurality of actuators, each actuator being selectively assigned at least one function and at least one domain;
a plurality of outlets, each outlet being selectively assigned to at least one actuator; and
a plurality of appliances, each appliance being connected to an outlet;
the method comprising:
disconnecting a first appliance from a first outlet;
identifying an assignment of the first outlet to a first actuator; and
disassociating the first outlet from the first actuator.

32. The method of claim 31, further comprising:
identifying an assignment of the first outlet to a second actuator; and
disassociating the first outlet from the second actuator.

33. The method of claim 31, further comprising
connecting the first appliance to a second outlet different from the first outlet;
determining if the first appliance is related to the assigned function and domain of each actuator; and
if the first appliance is related to the assigned function at least one actuator, controlling a supply of power to the second outlet with the at least one actuator.

34. The automation system of claim 1, wherein when the actuator is actuated, the at least one device provides power to the at least one appliance for a first period of time, and then selectively does not provide power for a second period of time.
